(19) United States
(12) Patent Application Publication
(10) Pub. No.: US 2004/0175156 A1
(43) Pub. Date: Sep. 9, 2004

(54) Method for video data backup

(75) Inventor: Hong-Chuan Wang, Taipei (TW)

Correspondence Address: BRUCE H. TROXELL, SUITE 1404, 5205 LEESBURG PIKE, FALLS CHURCH, VA, 22041, US

(73) Assignee: EPO Science & Technology Inc.

(21) Appl. No.: 10/379,665

(22) Filed: Mar. 6, 2003

(51) Int. Cl. H04N 5/781

(52) U.S. Cl. 386/125; 386/126

(57) ABSTRACT

A method for video data can process the backup a VCD with damage zones to overcome a deficiency of the conventional CD-RW drive being incapable of backing up a VCD with damage zones. The method is to read data saved in a directory zone of the data storage zone first and, then, confirm location of the damage zone. Next, the method allows the optical pickup to skip the damage zone during the process of backing up the data in the data storage zone so as to complete the backup job for the entire data storage zone without accessing the damage zone.

### BACKGROUND OF THE INVENTION

1. Field of the Invention

The present invention relates to a method for video data backup done with a rewritable CD drive and particularly to a method for backing up a VCD with a damage zone.

2. Description of Related Art

Due to the compact disk (CD) being getting cheaper and the storage capacity thereof being getting large with convenience of being stored up and carried about, it becomes popular that the video data is saved on a CD. However, it is very possible that the CD itself becomes broken or lost and the video data saved in the CD becomes damaged. Hence, it is significant that having a backup CD is an essential thing in order to keep important video data.

Referring to FIG. 1, a conventional CD 10 such as VCD is provided a damage zone 111 in the storage zone 11.

An ordinary rewritable CD drive usually copies all the data in the CD 10 from the beginning to the end. Once the optical pickup thereof moves to the damage zone, the operation of accessing the data is unable to be performed continuously such that the optical pickup stays at the damaged zone without moving further. In this way, it results in an incomplete backup job for the entire video data in the storage zone 11 of the CD 10.

### SUMMARY OF THE INVENTION

The crux of the present invention is to overcome the deficiency of the conventional data backup way done by the rewritable CD drive with which a VCD with damage zone is not possible to be backed up.

Accordingly, a primary object of the present invention is to provide a method for video data backup, which is capable of allowing the CD drive accessing the video data backup for a CD with damage zone.

### BRIEF DESCRIPTION OF THE DRAWINGS

The present invention can be more fully understood by reference to the following description and accompanying drawing, in which:

FIG. 1 is a plan view of VCD saving with video data; and

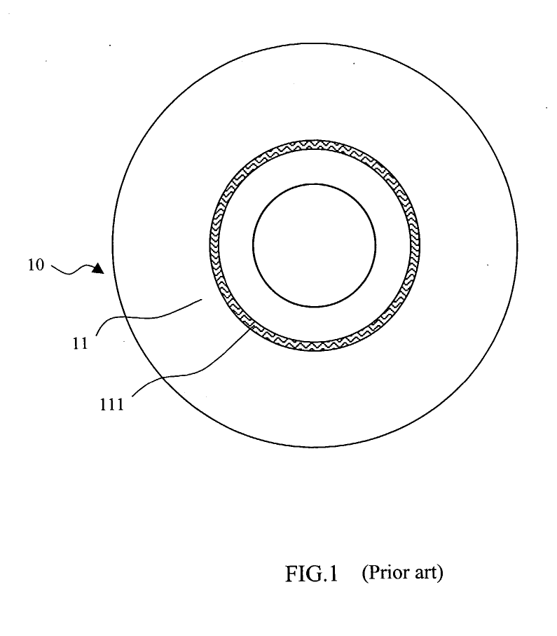

FIG. 2 is a flow chart of a method for video data backup according to the present invention;

### DETAILED DESCRIPTION OF THE PREFERRED EMBODIMENT

Generally, a compact disk (CD) saving video data has a directory zone for different CD player being able to read the video data successfully and the directory zone registers play options of the video data and location data of the damage zone. The back up method of the present invention basically allows the optical pickup to read the data saved in the directory zone and confirm the location of the damage zone before the operation of backing up being performed.

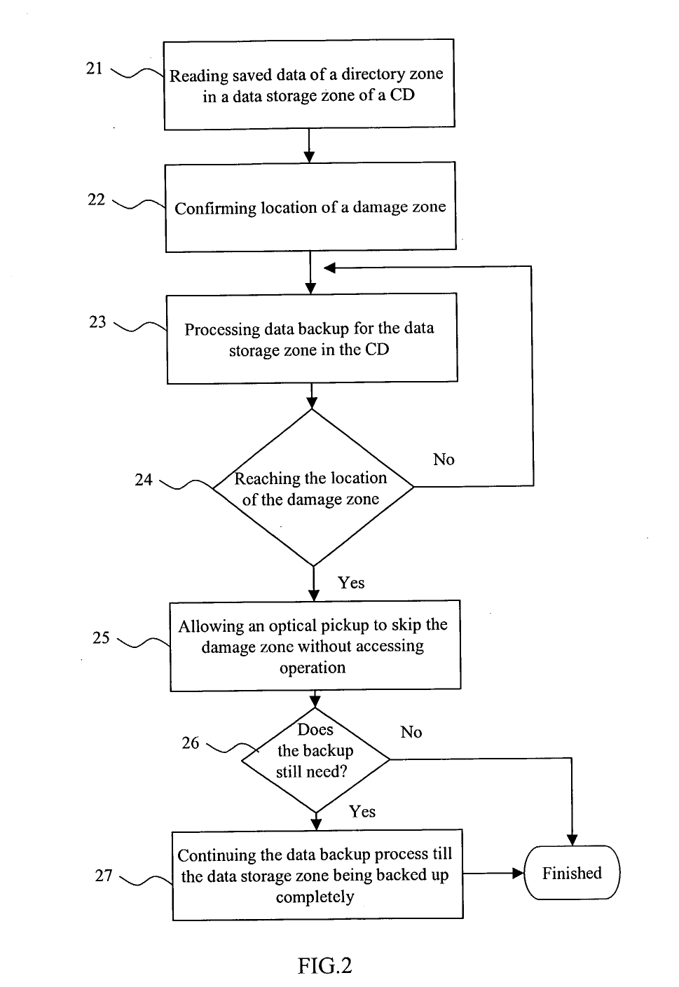

Referring to FIG. 2, the method for video data backup according to the present invention includes following steps:

21 reading saved data in the directory zone on a data storage zone in a compact disk;

22 confirming location of a damage zone;

23 processing data backup for the data storage zone of the compact disk;

24 entering next step in case of the backup reaching the location of the damage zone or continuing performing the backup in case of the location of the damage zone being not reached;

25 the optical pickup skipping the damage zone without accessing the damage zones;

26 Stopping the operation of backing up in case of no video data being necessary to be accesses otherwise entering next step;

27 Continuing the operation of data backup till the entire the data storage zone having been accessed completely.

It is appreciated that the method for video data backup of the present invention allows an optical pickup of a CD-RW drive skipping the location of damage zone during accessing the operation of backing up the video data instead of the conventional way that the optical pickup stays at the damage zones and the successive operation for the backup of entire data storage zone is not possible to access completely.

While the invention has been described with reference to a preferred embodiment thereof, it is to be understood that modifications or variations may be easily made without departing from the spirit of this invention, which is defined by the appended claims.

What is claimed is:

1. A method for video data backup, comprising following steps:
reading saved data in the directory zone on a data storage zone of a compact disk;
confirming location of a damage zone;
processing data backup for the data storage zone of the compact disk;
entering next step in case of the backup reaching the location of damage zone or continuing performing the backup in case of the location of damage zone being not reached;

2. The method for video data backup according to claim 1, wherein the optical pickup skips the damage zone and Continues the operation of data backup till the entire data storage zone having been accessed completely.
